(19) United States
(12) Patent Application Publication
(10) Pub. No.: US 2024/0173971 A1
(43) Pub. Date: May 30, 2024

(54) DETERMINATION METHOD FOR DRIVING FORCE OF PRINT HEAD, COMPUTER-READABLE STORAGE MEDIUM, MEASURING APPARATUS, AND PRINTING APPARATUS

(71) Applicant: CANON KABUSHIKI KAISHA, Tokyo (JP)

(72) Inventor: KENZOU SHIBUYA, Kanagawa (JP)

(21) Appl. No.: 18/517,444

(22) Filed: Nov. 22, 2023

(30) Foreign Application Priority Data
Nov. 24, 2022 (JP) 2022-187582

(51) Int. Cl. B41J 2/045

(52) U.S. Cl. CPC B41J 2/04558; B41J 2/04585

(57) ABSTRACT

A determination method for driving force of a print head that performs printing by discharging a droplet, the determination method comprising setting a plurality types of driving force of the print head, forming, by driving the print head in sequence using the plurality types of driving force being set, a first measurement pattern indicating a landing position of a droplet and a second measurement pattern indicating landing area of a droplet, and specifying one of the plurality types of driving force that satisfies a criterion, based on the first measurement pattern and the second measurement pattern.

### BACKGROUND OF THE INVENTION

### Field of the Invention

The present invention mainly relates to a determination method for driving force of a print head.

### Description of the Related Art

Among printing apparatuses such as ink jet printers, some printing apparatuses capture an image of a landing position of ink droplets and adjusts the driving timing and the position of the print head, based on a displacement amount between the landing position and an expected landing position (see Japanese Patent Laid-Open No. 2019-209672). According to such a technique, it becomes possible to cause ink droplets to land at a desired position, thereby improving the quality of printing.

The print head discharges ink droplets based on predetermined energy (thermal energy and the like in the case of an ink jet type). The energy may generally vary due to manufacturing irregularities, aging degradation and the like. Therefore, it can be said that the quality of printing can be further improved by taking into account the driving force of the print head for generating the aforementioned energy.

### SUMMARY OF THE INVENTION

The present invention further improves the quality of printing.

One of the aspects of the present invention provides a determination method for driving force of a print head that performs printing by discharging a droplet, the determination method comprising setting a plurality types of driving force of the print head, forming, by driving the print head in sequence using the plurality types of driving force being set, a first measurement pattern indicating a landing position of a droplet and a second measurement pattern indicating landing area of a droplet, and specifying one of the plurality types of driving force that satisfies a criterion, based on the first measurement pattern and the second measurement pattern.

Further features of the present invention will become apparent from the following description of exemplary embodiments (with reference to the attached drawings).

### BRIEF DESCRIPTION OF THE DRAWINGS

FIG. 1 is a schematic perspective diagram illustrating an appearance of a measuring apparatus according to an embodiment;

FIG. 2 is a block diagram illustrating a configuration example of a measuring apparatus;

FIG. 3 is a diagram illustrating a circuit configuration of a print head;

FIG. 4 is a flowchart illustrating an example of a method for determining a driving mode of a print head;

FIG. 5 is a schematic diagram illustrating an example of a landing position measurement pattern;

FIG. 6 is a schematic diagram illustrating an example of a discharge energy measurement pattern;

FIG. 7 is a schematic diagram illustrating an example of a captured image of a landing position measurement pattern;

FIG. 8 is a schematic diagram illustrating an example of a captured image of a discharge energy measurement pattern;

Each of FIGS. 9A and 9B is a diagram illustrating landing displacement amount and landing area being plotted;

Each of FIGS. 10A and 10B is a schematic perspective view illustrating an appearance of a printing apparatus according to an embodiment;

FIG. 11 is a block diagram illustrating a configuration example of a printing apparatus; and

FIG. 12 is a flowchart illustrating an example of a method for determining a driving mode of a print head.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

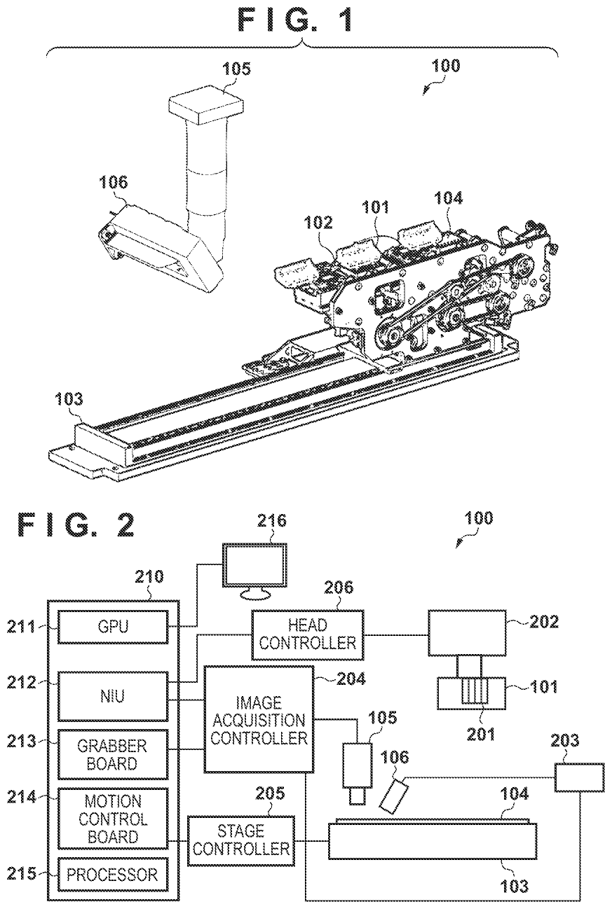

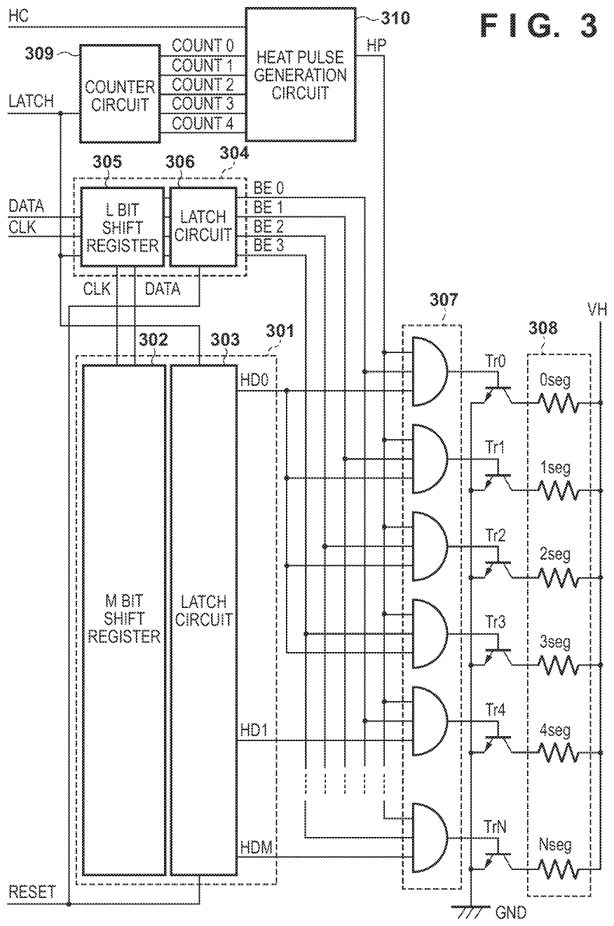

FIG. 1 is a perspective view of an appearance of a measuring apparatus 100 according to a first embodiment. FIG. 2 is a block diagram illustrating a configuration example of the measuring apparatus 100. The measuring apparatus 100 includes a print head 101, a carriage 102, a stage 103, a camera 105, and an illumination device 106. In addition, the measuring apparatus 100 further includes a head driver 201, a connection unit 202, an illumination controller 203, an image acquisition controller 204, a stage controller 205, a head controller 206, a control computer 210, and a monitor 216.

The print head 101 is configured such that the print head 101 can execute ink jet type printing, and can discharge droplets (typically, ink droplets) individually from a plurality of nozzles. The print head 101 is fixed by the carriage 102, and one or more head drivers 201 are mounted on the print head 101. The head controller 206 is electrically connected to the head driver 201 via the connection unit 202 which is a contact probe unit.

The stage 103 is a table configured to be placed with a sheet-like print medium 104 such as paper material, and may also be referred to as a paper stage and the like. The print medium 104 can be attracted onto the upper surface of the stage 103 by negative pressure suction, for example. An encoder may be provided to the stage 103 for acquiring position information. Here, surface coating may be applied to the print medium 104 such that the droplets discharged from the print head 101 and landed on to the print medium 104 are uniformly absorbed.

The print head 101 can also discharge droplets to form a measurement pattern (inspection pattern), which is formed on the print medium 104 on the stage 103. The stage 103 may be controlled by the stage controller 205 such that the measurement pattern formed on the print medium 104 is located within an angle of view of the camera 105 described below.

The camera 105 can capture and read an image of the measurement pattern. A line-sensor type CCD image sensor may be typically used for the camera 105, any other known image capturing apparatus may be used. The image data obtained by the camera 105 is transferred to a grabber board 213 described below, via the image acquisition controller 204.

The illumination device 106 may be positioned in the vicinity of the camera 105. The illumination device 106 can output light having wavelengths of, for example, Red light (R): 625 [nm], Green light (G): 528 [nm], and Blue light (B): 470 [nm]. It suffices to use a known light source such as an LED as the illumination device 106. The illumination controller 203 can control the light amount of each of the R, G and B of the illumination device 106 based on a control signal from the image acquisition controller 204.

The control computer 210 includes a GPU 211, an NIC 212, a grabber board 213, a motion control board 214 and a processor 215, and other electronic components may be further installed in the control computer 210.

The Graphics Processing Unit (GPU) 211 outputs video signals to the monitor 216. A Network Interface Card (NIC) 212 performs drive control of the print head 101 via the head controller 206. In addition, the control computer 210 performs drive control of the camera 105 and the illumination device 106 via the NIC 212 and the image acquisition controller 204, and acquires, by the grabber board 213, image data that is a result of capturing the image of the measurement pattern. The motion control board 214 performs drive control of the stage 103 via the stage controller 205. The processor 215 performs arithmetic processing for performing system control of the entire measuring apparatus 100 to perform drive control of each of the components 211 to 214.

FIG. 3 illustrates an example of the circuit configuration of the print head 101. In the print head 101, a plurality of heaters (electro-thermal converting elements) corresponding to a plurality of nozzles that can discharge droplets are arranged to form a heater group 308. When each of the plurality of heaters are driven, droplets are discharged from nozzles corresponding to the heaters.

The heater group 308 is assumed to be driven by a method so-called time-division method that divides a plurality of heaters into several groups and drives the heaters in sequence for each group. It is assumed in the present embodiment that four heaters are assigned to each group. The group is also referred to as a time-division group, and the heaters driven for each group may also be referred to as a time-division block or simply a block.

The print head 101 includes, in addition to the heater group 308, a print data supply unit 301, a print block selection unit 304, a logical product (AND) gate group 307, a counter circuit 309, and a heat pulse generation circuit 310.

The print data supply unit 301 includes an M-bit shift register 302 and a latch circuit 303. The M-bit shift register 302 stores print data DATA in synchronization with a clock signal CLK. The latch circuit 303 temporarily holds bit data of the M-bit shift register 302 (M bits of data) in response to a latch signal LATCH. Here, M is assumed to be an integer.

The print block selection unit 304 includes an L-bit shift register 305 and an L-bit decoder 306. The L-bit shift register 305 stores block data BDATA in synchronization with the clock signal CLK. The L-bit decoder 306 temporarily holds bit data of the L-bit shift register 305 (L bits of data) in response to the latch signal LATCH. Here, L is assumed to be 2.

AND gates of the AND gate group 307 receive block selection signals BE0 to BE3 from the print block selection unit 304, print data selection signals HD0 to HDM from the print data supply unit 301, and a heat pulse signal HP from the heat pulse generation circuit 310. The block selection signals BE0 to BE3 are control signals for selecting a heater (block) to be driven. The print data selection signals HD0 to HDM are control signals for determining whether or not to drive the selected heater (block). The heat pulse signal HP has a pulsed waveform for determining the energization time of the heater, and the heater can be energized during the High-level (H-level) time.

In the aforementioned manner, the transistors Tr0, Tr1, . . . , TrN are each controlled to be in a conductive state or a non-conductive state based on a signal from a corresponding AND gate and, and when the transistor is controlled to be in the conductive state, a corresponding heater (0seg, 1seg, . . . , Nseg) is energized. As such, driving of the heater group 308 can be realized in a time-division manner.

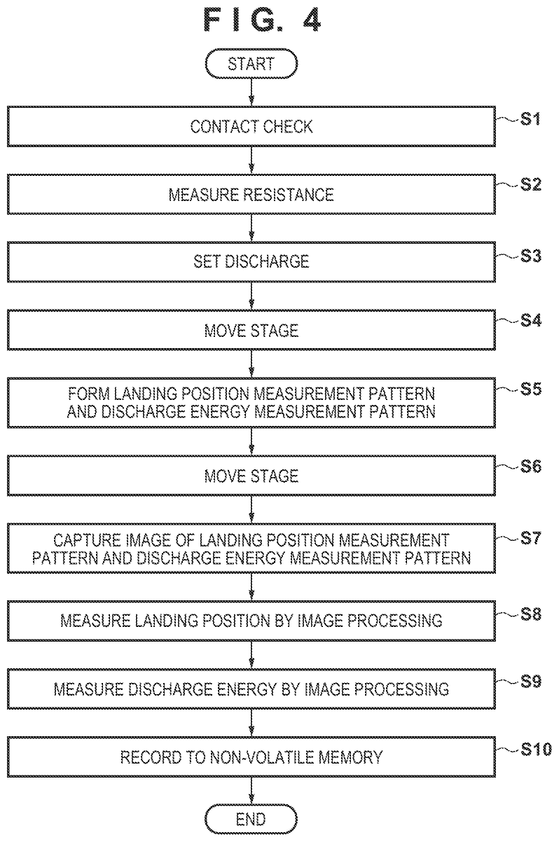

FIG. 4 is a flowchart illustrating an example of a method for determining the driving mode of the print head 101.

At Step S1 (simply referred to as “S1” below, same goes with other steps described later), contact check is performed for the head driver 201 and the head controller 206 installed in the print head 101. By this check, it is checked whether or not the head driver 201 and the head controller 206 are electrically connected.

At S2, an electric resistance value of the heater group 308 is measured. In the present embodiment, the transistor Tr0 and the like is controlled in a state where a driving voltage of 5 [V] is applied between VH and GND, and thus a pulsed drive signal of 5 [μs] is input to a corresponding heater. The electric resistance value may be calculated and measured based on a current amount Is as,

(5.0−Vs)/Is
where a current amount Is generated by measuring, for example, a potential difference Vs between both ends of a shunt resistor.

At S3, discharge setting is performed for specifying the energization time of the heater. An appropriate value of energy required for discharging droplets (discharge energy, in the following) may vary depending on manufacturing irregularities of heaters, and therefore an appropriate value of discharge energy must be set. When, for example, the discharge energy is lower than a reference value, droplets may not be appropriately discharged, whereby the landing position of the droplets may shift from a desired position. When, on the other hand, the discharge energy is higher than the reference value, elements around the heater may be unnecessarily heated, which may lead to disconnection of the heater or the like. Therefore, at S3, a specification signal (energization time specification signal HC, in the following) is set for provisionally specifying the energization time of the heater for discharging the droplets. In the present embodiment, the energization time specification signal HC is set based on an electric resistance value of the heater measured at S2.

Here, the aforementioned discharge energy may be calculated by integrating a voltage value of a driving voltage VH and the energization time of the heater. In the present embodiment, the voltage value of the driving voltage VH is a fixed value (e.g., 24 [V]), and the energization time of the heater is variable. In such a case, the energization time may be provisionally set based on the electric resistance value (average resistance value) of the heater, in other words, the discharge energy may be provisionally determined based on the set energization time. The value determined here may also be referred to as a provisional value.

At S4, the stage 103 is moved such that a measurement pattern can be formed on the print medium 104 on the stage 103. The moving speed of the stage 103 is determined in accordance with the discharge characteristics of the print head 101, and set to 25 [inch/sec] in the present embodiment.

At S5, a landing position measurement pattern and a discharge energy measurement pattern are formed as measurement patterns on the print medium 104 on the stage 103. The landing position measurement pattern is a measurement pattern for measuring the landing positions of droplets (first measurement pattern), details of which will be described below. The discharge energy measurement pattern is a measurement pattern for measuring the discharge energy of discharged droplets (second measurement pattern). The landing position measurement pattern and the discharge energy measurement pattern are formed by determining, based on the position information of the encoder of the stage 103, the timing at which droplets are discharged from the print head 101. The foregoing allows for measuring the landing position of a droplet and the discharge energy of the droplet in association with each other.

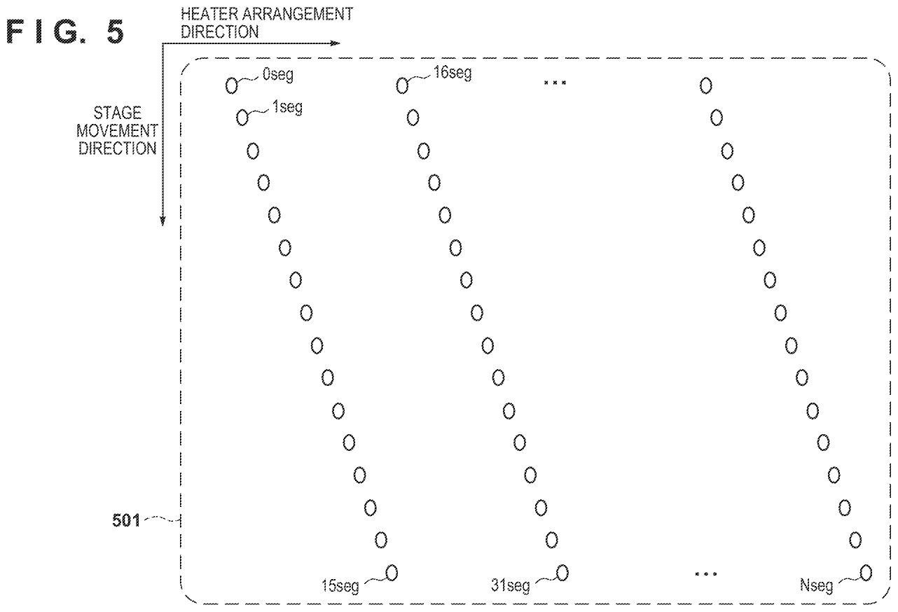

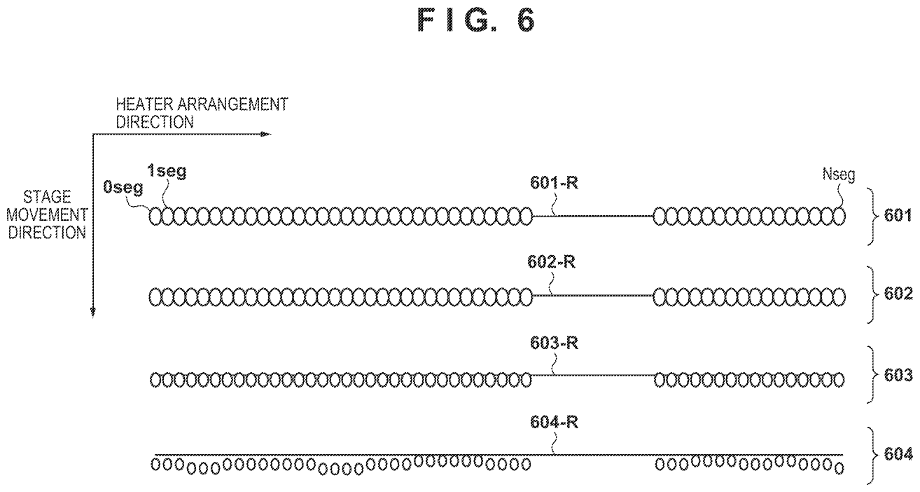

Here, an example of the landing position measurement pattern and the discharge energy measurement pattern will be described, referring to FIG. 5 and FIG. 6, respectively.

FIG. 5 schematically illustrates a landing position measurement pattern 501. The landing position measurement pattern 501 may be formed based on the energization time specification signal HC set at S3, such that droplets discharged from individual heaters do not overlap with each other, i.e., a sufficient gap is provided between dots of droplets.

FIG. 6 schematically illustrates a plurality of discharge energy measurement patterns 601 to 604 (collectively referred to as discharge energy measurement pattern 601 and the like in the following when they are not distinguished from each other). Each of the discharge energy measurement pattern 601 and the like is formed by dots of one or more droplets.

The discharge energy measurement pattern 601 is formed by the driving voltage VH and the energization time specification signal HC (referred to as signal HC1 to distinguish it from patterns 602 to 604 described below) with the target landing position of a droplet being set to a position 601-R. Here, the discharge energy measurement pattern 601 is formed under same condition as that for the landing position measurement pattern 501, and therefore a pattern is formed with the same landing characteristics as that for the landing position measurement pattern 501.

The discharge energy measurement pattern 602 is formed by a signal specifying a value smaller than the signal HC1 by 0.02 [μs] (referred to as energization time specification signal HC2) with the target landing position of a droplet being set to a position 602-R. The discharge energy measurement pattern 603 is formed by a signal specifying a value smaller than the signal HC2 by 0.02 [μs] (referred to as energization time specification signal HC3) with the target landing position of a droplet being set to a position 603-R. The discharge energy measurement pattern 604 is formed by a signal specifying a value smaller than the signal HC3 by 0.02 [μs] (referred to as energization time specification signal HC4) with the target landing position of a droplet being set to a position 604-R.

In a similar procedure, 50 discharge energy measurement patterns, for example, are formed on the print medium 104 (the remaining 46 patterns are omitted in the drawing). As in the discharge energy measurement patterns 602, 603, 604 and subsequent patterns, the discharge energy is gradually decreased, and thus a flying speed of droplet is also decreased and a discharge amount of droplet is also reduced. Therefore, in the discharge energy measurement patterns 602, 603, 604 and subsequent patterns, a displacement amount from the target landing position is increased, and a landing area of droplet is reduced.

As such, in the print medium 104, a measurement pattern including a landing position measurement pattern 501, a plurality of discharge energy measurement patterns 601 and the like are formed.

Referring to FIG. 4 again, the stage 103 is moved, at S6, to a position where the camera 105 can capture an image such that the camera 105 can capture an image of the landing position measurement pattern 501, the plurality of discharge energy measurement patterns 601 and the like which have been formed on the print medium 104.

At S7, an image of the aforementioned measurement patterns is captured by the camera 105 and transferred to the control computer 210.

At S8, landing characteristics of the droplets discharged by each heaters are measured, based on the image of the landing position measurement pattern 501 captured at S7.

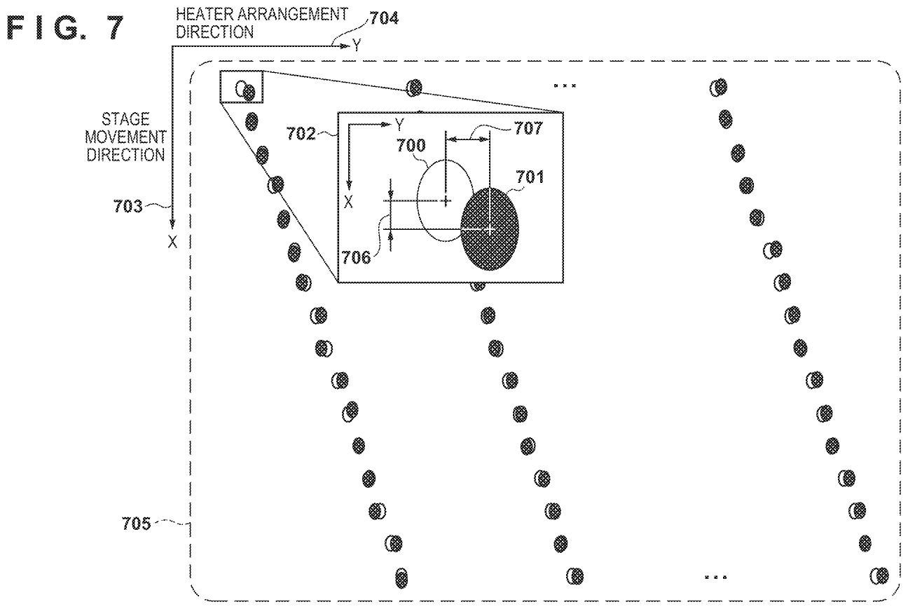

FIG. 7 illustrates an example of a captured image 705 of the landing position measurement pattern 501, similarly to FIG. 5. In the drawing, a moving direction 703 of the stage 103 is taken as the X-axis, and an arrangement direction 704 of the heaters is taken as the Y-axis. A white circle 700 indicates a target landing position of a droplet corresponding to the 0seg heater, and a black circle 701 indicates an actual landing position of the droplet corresponding to the 0seg heater. As illustrated in the enlarged image 702, a positional displacement amount 706 in the X direction and a positional displacement amount 707 in the Y direction between the target landing position 700 and the actual landing position 701 are measured as landing characteristics. Here, the displacement amount may be referred to as landing displacement amount in the following description.

Referring to FIG. 4 again, a discharge energy within a tolerable range is specified or determined at S9, based on the plurality of discharge energy measurement patterns 601 and the like.

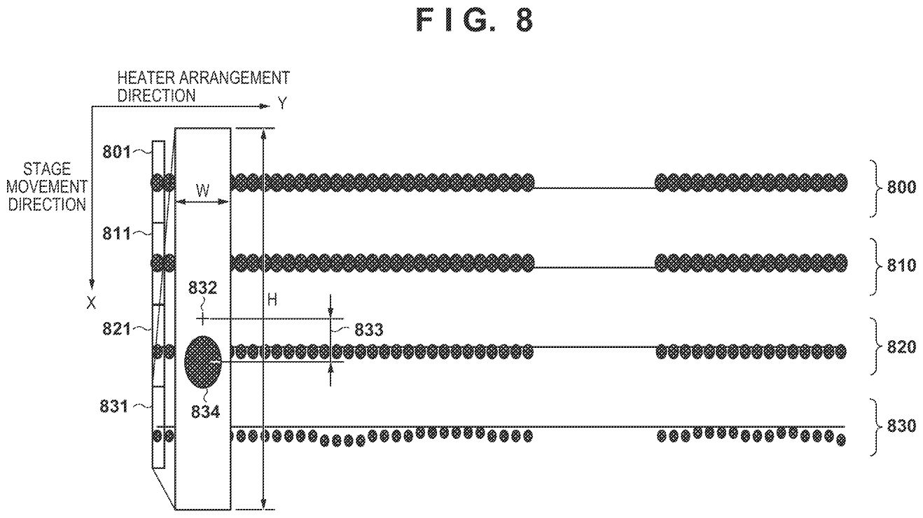

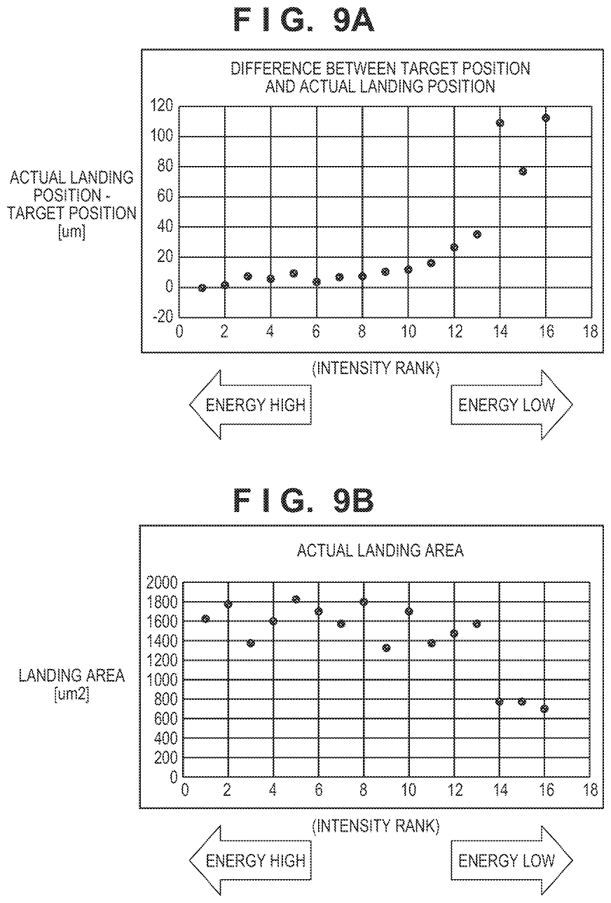

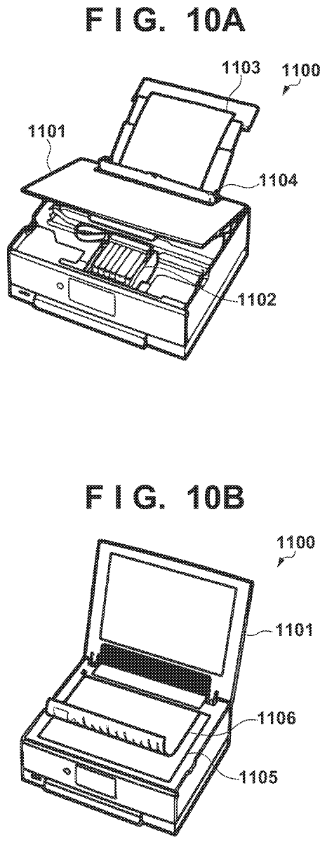

FIG. 8 illustrates an example of captured images 800, 810, 820 and 830 of the discharge energy measurement patterns 601, 602, 603 and 604, similarly to FIG. 6.

First, a method of selectively retrieving a captured image of each heater from the captured image 830 will be described, as an example. An image region 831 is set based on the target landing position 700 which is fed back with the landing characteristics corresponding to the heater of the 0seg obtained at S8. In the present embodiment, the image region 831 is set with the target landing position, which is fed back with the landing characteristics corresponding to the 0seg heater, as the center 832, the heater width as an image width W, and the distance between the target landing positions 601-R and 602-R as an image length H. Here, these parameters may be partially adjusted for a purpose of shortening of the time required for measurement, and therefore the width of two or more heaters may be used as the image width W, for example.

Here, description will be provided focusing on 0seg, a captured image for each heater is selectively retrieved from the captured image 830 by performing the same procedure for 1seg to Nseg. In addition, the same goes for the captured images 800, 810 and 820 as well as other captured images, and thus a captured image for each heater can be selectively retrieved from any of the captured images.

A landing displacement amount 833 and a landing area 834 of droplets in the X direction are measured for image regions 801, 811, 821, 831 and subsequent image regions corresponding to the 0seg heater retrieved as described above.

FIG. 9A is a graph in which the landing displacement amount 833 in the X direction is plotted with the landing displacement amount as the vertical axis, with respect to the order of the image regions 801, 811, 821, 831 and subsequent image regions in the horizontal axis (descending order of discharge energy). FIG. 9B is a graph in which the landing area 834 is plotted with the landing area as the vertical axis in a similar manner.

As can be seen in FIG. 9A, when the discharge energy goes lower, the landing displacement amount becomes larger. In contrast, when the discharge energy goes lower, the landing area becomes smaller, as can be seen in FIG. 9B.

Therefore, the tolerable range of the discharge energy may be specified or determined by providing threshold values for the landing displacement amount and the landing area. Specifically, a tolerable upper limit value of the landing displacement amount and a tolerable lower limit value of the landing area may be respectively set as thresholds for the image region 801 and the like, and then a range of discharge energy satisfying the thresholds may be specified or determined as the tolerable range of discharge energy in driving the 0seg heater.

It is assumed in the present embodiment that the threshold value corresponding to the tolerable upper limit value of the landing displacement amount is set to 20 [μm], and the threshold value corresponding to the tolerable lower limit value of the landing area is set to 1000 [μm²]. In other words, the tolerable range of the discharge energy in the present embodiment is a range in which the landing displacement amount is equal to or smaller than 20 [μm] and the landing area is equal to or larger than 1000 [μm²]. These threshold values may be set based on, for example, the discharge control cycle of the print head 101, the size of the nozzle of the heater 308, and the like.

In another embodiment, the tolerable range of the discharge energy may be determined based on a landing density value in place of the landing area.

The tolerable range of the discharge energy in driving can be specified or determined for all the heaters by performing a similar procedure for 1seg to Nseg.

It suffices to employ one (e.g., minimum value, median, etc.) satisfying a predetermined condition among the tolerable range of the discharge energies specified or determined in the aforementioned manner, for each heater as discharge energy in the following discharging.

Referring to FIG. 4 again, the discharge energy determined at S9 is stored in a non-volatile memory (not illustrated) at S10. The non-volatile memory may store the energization time in place of the discharge energy. The nonvolatile memory is typically installed in the print head 101, and individual information such as ID and manufacturing date and time of the print head 101 may be written in the nonvolatile memory.

According to the present embodiment, the measuring apparatus 100 can measure the printing accuracy or printing performance of the print head 101 by capturing images of the aforementioned measurement patterns formed on the print medium 104 and performing image processing or image analysis. Based on the measurement result, the discharge energy may be specified for each heater with taking into account manufacturing irregularities, whereby the energization time or driving force of a plurality of heaters may be individually determined, such that droplets are discharged in a desired manner from every nozzle. Therefore, the present embodiment allows for improving the quality of printing by the print head 101.

Here, an aspect has been exemplified in the present embodiment in which a tolerable range of the discharge energy is specified by setting a voltage value of the driving voltage VH to be fixed value and an energization time of the heater to be variable, the value to be variable however is not limited to the present example as long as the driving force of the heater can be specified. For example, the voltage value of the driving voltage VH may be variable, or additionally or alternatively, the signal level of the control signal for energizing the heater may be variable.

In addition, specification or determination of the discharge energy corrects the discharge energy provisionally set at S3, and therefore the specification or the determination of the discharge energy may be referred to as correction of the discharge energy.

In addition, a heater is exemplified as a droplet discharge method in the embodiment, other known discharge elements such as a piezoelectric element may be used.

### Second Embodiment

At S9 described above (see the first embodiment), there is a possibility that the landing displacement amount may increase when the discharge energy decreases, making droplets to land outside the image region. For example, there is a possibility that droplets may land outside the region of the image regions 801, 811, 821, 831 and subsequent image regions about the heater of 0seg.

Therefore, enhancing the robustness with regard to the landing displacement amount is taken into account as one of the purpose, the image region 801 and the like may be expanded by setting the distance between the target landing positions 601-R and 603-R as the image length H.

Accordingly, the discharge energy with taking into account the manufacturing irregularities of heaters can be relatively easily specified or determined, even when the discharge energy decreases and the landing displacement amount increases.

### Third Embodiment

FIG. 10A is an external perspective view of a printing apparatus 1100 that can execute ink jet type printing. The printing apparatus 1100 includes, at an upper portion, a lid 1101 that can be opened and closed, and FIG. 10B is an external perspective view of the printing apparatus 1100 in a state of the lid 1101 being open.

The printing apparatus 1100 includes, for example, a print head 1102 and a sheet feeding mechanism 1104. A serial head may be used as the print head 1102, which performs printing on a print medium conveyed in a predetermined direction while the print head is scanned in a direction crossing the conveyance direction. The sheet feeding mechanism 1104 loads a print medium 1103 such as a paper material into the printing apparatus 1100, and the print head 1102 performs printing on the print medium 1103 thus loaded. In the present embodiment, the printing apparatus 1100 is configured to convey the print medium 1103 in a forward and backward direction, and perform printing on the print medium 1103 while the print head 1102 is reciprocating in the width direction of the apparatus.

While the lid 1101 is in the open state, a document 1106 that is a target of image capturing can be placed on a document table 1105, and an image of the document 1106 can be captured by an image capturing apparatus described below, which is built in the printing apparatus 1100. Here, the image of the document 1106 may generally include characters, symbols, figures, photographs and the like, as well as blanks that may be formed therebetween.

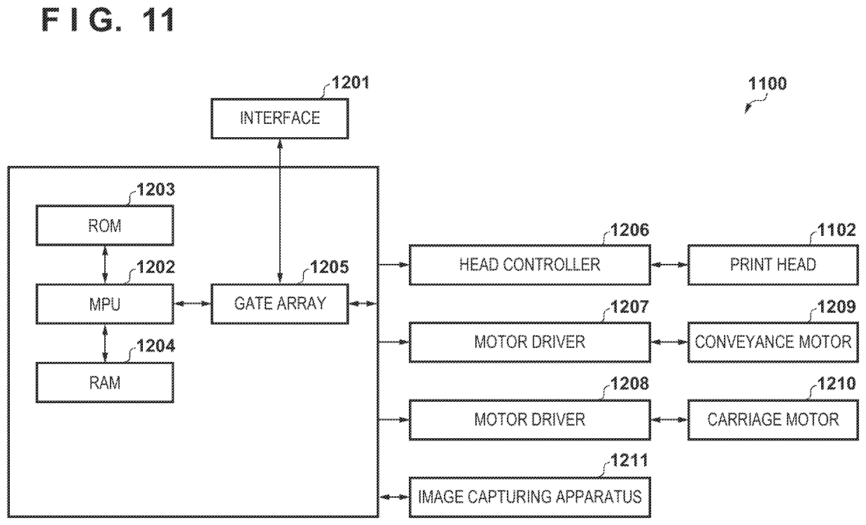

FIG. 11 is a block diagram illustrating a configuration example of the printing apparatus 1100 The printing apparatus 1100 further includes an interface 1201, an MPU 1202, a ROM 1203, a RAM 1204, and a gate array 1205. In addition, the printing apparatus 1100 further includes a head controller 1206, motor drivers 1207 and 1208, a conveyance motor 1209, a carriage motor 1210, and an image capturing apparatus 1211.

The interface 1201 receives a print job or a print signal from the outside. The Micro Processing Unit (MPU) 1202 executes various programs required for implementing respective functions of the printing apparatus 1100. The Read Only Memory (ROM) 1203 stores programs executed by the MPU 1202. The Random Access Memory (RAM) 1204 functions as a work area for the MPU 1202 to execute a program, and may temporarily store information such as print data, parameters and the like that are required for executing printing. A Dynamic Random Access Memory (DRAM) and the like may be used for the RAM 1204.

The gate array 1205 transfers the print job or the print signal received via the interface 1201 to the MPU 1202. The MPU 1202 generates print data based on the transferred print job or print signal, and supplies the print data to the print head 1102 via the gate array 1205.

The head controller 1206 performs drive control of the print head 1102 based on print data. The motor driver 1207 performs drive control of the conveyance motor 1209 based on the print data, thereby driving the sheet feeding mechanism 1104 to convey the print medium 1103. The motor driver 1208 performs drive control of the carriage motor 1210 based on print data, thereby driving the print head 1102 to perform printing on the print medium 1103.

The image capturing apparatus 1211 allows for capturing an image of the document 1106 placed on the document table 1105, details of which will be described below.

Here, in a case where the printing apparatus 1100 has been used for a long time period, the discharge energy of droplets in the print head 1102 may generally decrease due to aging degradation, for example. Therefore, the discharge energy may be corrected or adjusted after the print head 1102 is installed in the printing apparatus 1100.

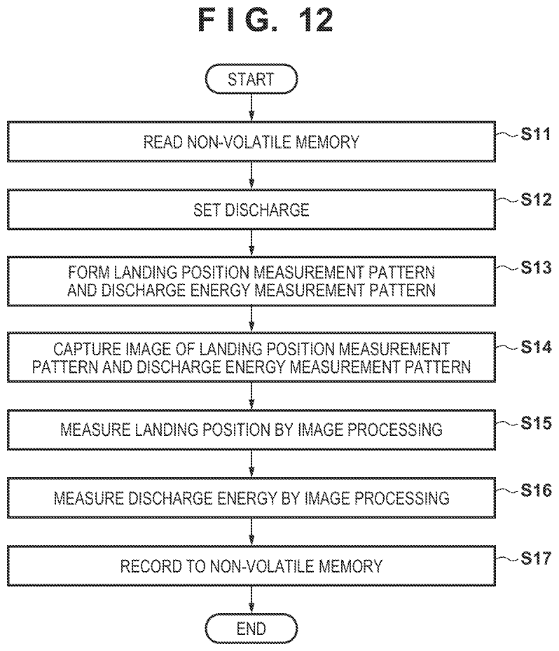

FIG. 12 is a flowchart for correcting the discharge energy for the print head 1102 according to the present embodiment.

At S11, a provisional value of the discharge energy is read from a non-volatile memory (not illustrated) installed in the print head 1102. The provisional value of the discharge energy may be preliminarily acquired and stored in the non-volatile memory at manufacturing of the printing apparatus 1100, for example. Alternatively, the value may be provisionally determined based on the electrical resistance value of the heater of the print head 1102, similarly to the first embodiment described above (see S3).

At S12, the energization time specification signal HC is set based on the discharge energy acquired at S11.

At S13, a landing position measurement pattern for measuring the landing position of the droplets discharged from the print head 1102 and a plurality of discharge energy measurement patterns for measuring the discharge energy of the discharged droplets are formed on the print medium 1103 as measurement patterns. Here, it is assumed that the landing position measurement pattern 501 and the plurality of discharge energy measurement patterns 601 and the like are formed, similarly to the first embodiment described above. The carriage speed of the print head 1102 is determined by the discharge characteristics of the print head 1102, and is assumed to be 25 [inch/sec] in the present embodiment.

At S14, the print medium 1103, on which the landing position measurement pattern 501, the discharge energy measurement pattern 601 and the like are formed, is placed on the document table 1105, and an image of the print medium 1103 is acquired by the image capturing apparatus 1211.

At S15, landing characteristics of droplets discharged from each of the heaters are measured based on the landing position measurement pattern 501 captured at S14, similarly to the first embodiment described above (see S8).

At S16, a discharge energy within the tolerable range is specified or determined based on the plurality of discharge energy measurement patterns 601 and the like, similarly to the first embodiment (see S9).

At S17, the discharge energy specified or determined at S16 is stored in a non-volatile memory (not illustrated), similarly to the first embodiment described above (see S10).

As such, it is possible to appropriately correct or adjust the discharge energy which may decrease due to the aging degradation or the like of the printing apparatus 1100.

According to the present embodiment, it is possible to correct or adjust the discharge energy, based on the aforementioned measurement patterns formed on the print medium 1103, such that droplets are discharged in a desired mode from any of the nozzles, even after the print head 1102 is applied to the printing apparatus 1100. Therefore, the present embodiment allows for improving or maintaining the quality of printing by the print head 1102, even after the print head 1102 is applied to the printing apparatus 1100.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Individual components in the foregoing embodiments are named using expressions based on their main functions, the functions mentioned in the embodiments may be sub-functions and the nomenclature is not strictly limited to such expressions. In addition, the expressions are replaceable by similar expressions. To the same effect, expressions such as “unit” or “portion” can be replaced by “tool”, “component”, “member”, “structure”, “assembly” or the like. Alternatively, they may be omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-187582, filed on Nov. 24, 2022, which is hereby incorporated by reference herein in its entirety.

What is claimed is:

1. A determination method for driving force of a print head that performs printing by discharging a droplet, the determination method comprising:
setting a plurality types of driving force of the print head;
forming, by driving the print head in sequence using the plurality types of driving force being set, a first measurement pattern indicating a landing position of a droplet and a second measurement pattern indicating landing area of a droplet; and
specifying one of the plurality types of driving force that satisfies a criterion, based on the first measurement pattern and the second measurement pattern.

2. The determination method according to claim 1, wherein, in the forming of the first measurement pattern and the second measurement pattern, the print head is driven, while the print head is scanning with respect to a print medium, in sequence, by the plurality types of driving force being set.

3. The determination method according to claim 2, wherein the first measurement pattern and the second measurement pattern are each formed such that the dots of droplets formed on the print medium do not overlap with each other.

4. The determination method according to claim 1, wherein the criterion includes that a displacement amount of the landing position is equal to or less than a tolerable upper limit value in the first measurement pattern, and that the landing area is equal to or larger than a tolerable lower limit value in the second measurement pattern.

5. The determination method according to claim 4, wherein the tolerable upper limit value of the displacement amount of the landing position is 20 [μm].

6. The determination method according to claim 4, wherein the tolerable lower limit value of the landing area is 1000 [μm²].

7. The determination method according to claim 1, wherein
the print head includes a plurality of discharge elements each configured to discharge a droplet, and
driving force satisfying the criterion for each of the discharge elements are specified in the specifying.

8. The determination method according to claim 7, wherein
each of the plurality of discharge elements is configured such that the discharge element can discharge a droplet when the discharge element is energized, and
the driving force of the individual discharge element corresponds to an energization time for the discharge element.

9. A non-transitory computer-readable storage medium storing a program that causes a computer to execute each processing in the determination method according to claim 1.

10. A measuring apparatus configured to measure accuracy of a print head that performs printing by discharging a droplet, the apparatus comprising:
a setting unit configured to set a plurality types of driving force of the print head;
a driving unit configured to form, by driving the print head in sequence using the plurality types of driving force being set, a first measurement pattern indicating a landing position of a droplet and a second measurement pattern indicating landing area of a droplet; and
a specifying unit configured to specify one of the plurality types of driving force that satisfies a criterion, based on the first measurement pattern and the second measurement pattern.

11. The measuring apparatus according to claim 10, wherein the criterion includes that a displacement amount of the landing position is equal to or less than a tolerable upper limit value in the first measurement pattern, and that the landing area is equal to or larger than a tolerable lower limit value in the second measurement pattern.

12. The measuring apparatus according to claim 10, wherein
the print head includes a plurality of discharge elements configured to be able to discharge a droplet when the discharge element is energized, and
the driving force corresponds to an energization time for each discharge element.

13. A printing apparatus comprising a printing unit configured to perform printing by discharging a droplet; a scanning unit configured to cause the printing unit to scan; and a conveyance unit configured to convey a print medium, the printing apparatus further comprising:
a setting unit configured to set a plurality types of driving force of the printing unit;
a print control unit configured to form, by driving the printing unit in sequence using the plurality types of driving force being set, a first measurement pattern indicating a landing position of a droplet and a second measurement pattern indicating landing area of a droplet with respect to the print medium;
an image capturing unit configured to capture images of the first measurement pattern and the second measurement pattern formed on the print medium; and
a specifying unit configured to specify one of the plurality types of driving force that satisfies a criterion, based on the first measurement pattern and the second measurement pattern captured by the image capturing unit.
